(19) United States
(12) Patent Application Publication
(10) Pub. No.: US 2020/0050540 A1
(43) Pub. Date: Feb. 13, 2020

(54) INTERACTIVE AUTOMATION TEST

(71) Applicant: International Business Machines Corporation, Armonk, NY (US)

(72) Inventors: Yang Gao, Xi'an (CN); Yuan Yuan He, Xi'an (CN); Jing Chen, Xi'an (CN); Shuai Zhang, Xi'an (CN)

(21) Appl. No.: 16/100,411

(22) Filed: Aug. 10, 2018

(51) Int. Cl. G06F 11/36; G06F 11/34; G06F 9/451

(52) U.S. Cl. CPC G06F 11/3692; G06F 11/3688; G06F 3/04842; G06F 9/451; G06F 11/3438

(57) ABSTRACT

A method for performing an interactive automation test. The method may comprise detecting a user interaction with a first test object of a user interface, monitoring an effect of the user interaction with the first test object, comparing a result of the user interaction with a list of one or more possible results, and reporting the results of the comparison.

### BACKGROUND

The present disclosure relates to software test, and more specifically, to automation test for software.

Software testing may help to evaluate the quality of software and verify whether the functionality of the software behaves as expected. Nowadays, software testing may be automated by executing an automation test using an automation test case.

### SUMMARY

Some embodiments of the present disclosure can be illustrated by a method for, performing an interactive automation test. The method may comprise (a) detecting a user interaction with a first test object of a user interface, (b) monitoring an effect of the user interaction with the first test object, (c) comparing a result of the user interaction with a list of one or more possible results, and (d) reporting the results of the comparison.

Some embodiments of the present disclosure can also be illustrated by a system comprising a processor and a memory in communication with the processor, the memory containing program instructions that, when executed by the processor, are configured to cause the processor to perform a method for (a) detecting a user interaction with a first test object of a user interface, (b) monitoring an effect of the user interaction with the first test object, (c) comparing a result of the user interaction with a list of one or more possible results, and (d) reporting the results of the comparison.

Some embodiments of the present disclosure can also be illustrated by a computer program product comprising a computer readable storage medium having program instructions embodied therewith, the program instructions executable by a computer to cause the computer to (a) detect a user interaction with a first test object of a user interface, (b) monitor an effect of the user interaction with the first test object, (c) compare a result of the user interaction with a list of one or more possible results, and (d) report the results of the comparison.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 illustrates an example method 100 an interactive automation test with a user interaction event according to an embodiment of the present disclosure.

FIG. 2 illustrates an example method 200 of maintaining associations and monitoring user interaction events for an interactive automation test.

FIG. 3 is a graphical representation of an exemplary interactive automation test system and its components, according to an embodiment of the present disclosure.

FIG. 4 illustrates an example method 400 of a user interaction with an interactive automation test, according to an embodiment of the present disclosure.

FIG. 5 depicts a computer system in accordance with an exemplary embodiment of the present invention.

FIG. 6 depicts a cloud computing environment according to an embodiment of the present disclosure.

FIG. 7 depicts abstraction model layers according to an embodiment of the present disclosure.

### DETAILED DESCRIPTION

The present disclosure describes a testing platform that utilizes user interactions with a user interface (UI) to test the functionality of a system.

Many commercial software products rely on automated test platforms to support quality assurance of their development cycles and product releases. Some test platforms can utilize existing automation test frameworks and libraries to develop automation test cases based on end-to-end use cases of their software products. Test platforms may also require a human testing component to access the look, feel, visual/audio effect, etc. of the software.

Creating a test platform for software (web pages, applications various user interfaces) can be a complex process. The test modes can be divided into two parts, a navigating component and a functionality component. The navigating component provides access and navigation of the software for the testing platform. For example, navigating could include manipulating a scroll bar, entering values into an input box, expanding a view with a combination of clicks by a mouse, clicking a left mouse button in the display to open a new window with a new webpage, clicking a left mouse button on a link in the display to direct a current web page window to a new web page, typing in a new webpage address into an address bar to direct the window to a new page, and/or opening a popup window when a curser moves over a window on a display. The functionality component tests the behavior of the UI elements. The end use cases can simulate a specific input and determine whether the output matches a pre-defined behavior. For example, once a button in the user interface is left clicked, the test platform could determine what function the left click of the button has (e.g., user interface directed to a different web address, calculation performed, etc.).

Typically, automation requires a significant portion of the development to go towards navigating the test object by simulating the actions of the user. Typically, development related to the navigating component can consume 30˜40 percent of the development process. The navigating elements must be designed to engage each aspect of the user interface that needs to be tested. For example, the activation (e.g., by a left click of a mouse) of each button in a user interface will need to be developed into the test platform.

Further, the navigating elements of the testing platform may need to be changed for each new iterations of the user interface are created, whenever new features are added, and anytime new technology is integrated. For example, with each new version of a web page a new version of the navigating elements of the testing platform will need to be created. In some embodiments, the present disclosure utilizes manual testing by a user in place of automated inputs for the navigating elements of the test platform. Some embodiments of the present disclosure may reduce development and maintenance efforts for a user interface by reducing the number of or extent of the navigating elements required for a testing platform.

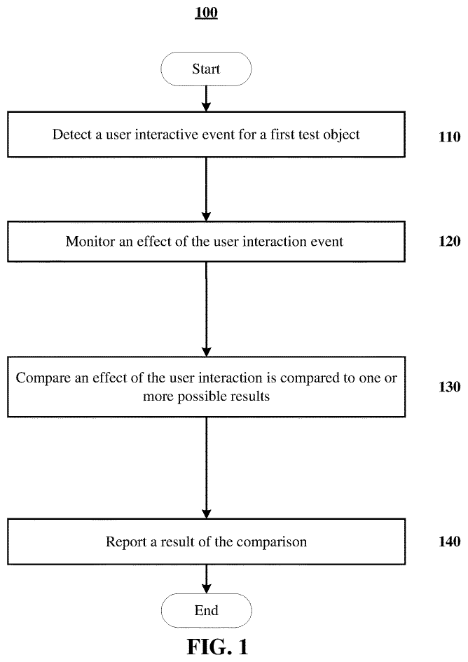

FIG. 1 illustrates an example embodiment of a method 100 by which user interactions with a user interface (e.g., user interaction events) may be used by a testing platform to perform a test by a testing platform. Method 100 may be beneficial in reducing the requirements of navigating elements by the testing platform. For example, method 100 may be used to monitor a user interface application by comparing the effect of a user action in the user interface with one or more test cases, where the one or more test cases include one or more possible outcomes of the one or more user interactions.

In block 110, a user interactive event for a first test object (e.g., a test element) may be detected by the testing platform. For example, a user interactive event could be the user clicking a button displayed on a user interface screen logically connected to a user interface. An example of the detection could be the testing platform detecting the user clicking a button displayed on a user interface screen logically connected to a user interface.

In block 120, an effect of the user interaction event is monitored by the testing platform. For example, the testing platform could detect whether a button directs an internet browser to new webpage and what the new webpage is. Other interactions and effects are possible. For example, an arrow key on a keyboard could command the user interface to skip to the next song, video, or image, where the user interface is a service that provides the user with particular songs, videos, or images.

In block 130, the effect of the user interaction is compared to one or more possible outcomes. In some embodiments, the one or more possible outcomes could be from one or more possible test cases associated with the first test object. For example, the test cases could be the clicking of a button displayed on a web browser with the possible effects being redirecting the browser to an identified webpage, redirecting the browser to any other webpage, or having no effect.

In block 140 a result of the comparison is reported to the testing platform or a user. For example, a desired result could be when the user clicks a button and it directs him to the webpage identified in the outcome of the test case. For example, an undesired result could be when the user clicks a button and it does not direct him to the webpage identified in the outcome of the test case. In some embodiments, the result may only be reported directly to a user if there is an undesired result (e.g., directing to any other webpage, or there is no effect).

The method 100 may be performed on a software application including at least one of a user interface (UI) application (e.g., a graphical user interface (GUI) application, a website UI application), a client application, a web service, a command line-executed application, or any other kind of software applications.

The first test object may be a test object among one or more test objects. Each test object may be one or more elements included in the software application to be functionally tested. Exemplary test objects may include an icon or a button in a UI application (e.g., the search button on a web page), a functional module in a client application, a service block in a web service, a piece of code in a command line-executed application, and so on.

The user interaction events for the one or more test objects may include, but is not limited to, a keyboard operation (such as a keyboard press, a keyboard input), a mouse operation (such as a left-click, right-click, double-click, drag), a screen touch (such as a tab, touch and hold, drag and drop), an audio input (such as an utterance of the name of the test object through a microphone), and/or a video input (such as a gesture indicating or pointing to the test object through a camera) for the one or more test objects. Exemplary user interaction events for test objects may be a left-click on a button in a UI application, a keyboard input of a command line for a command line-executed application, and so on.

In some embodiments, for one test object, only one kind of user interaction event will be considered as applicable and used testing platform. For example, clicking a button could be an applicable user event for one test object and other user events, such as scrolling over a button, could be regarded as inapplicable. In some embodiments, for one test object, there are several kids of user interaction events that will be considered as applicable and used by the testing platform. For example, both clicking a button and scrolling over a button could be regarded as applicable.

In some embodiments, the user interaction events for the one or more test objects may be continuously or periodically monitored so as to determine whether any of the user interaction events happen. Various technologies may be used to monitor the user interaction events and may be integrated with the present disclosure to monitor the user interaction events.

In some embodiments, during the monitoring of the user interaction events, various technologies may be used to detect the user interaction events. If a user interaction event for the first test object is detected, a signal indicating the detection may be generated and be used.

In the present disclosure, for a software application, there may be a plurality of test cases for testing functionalities of one or more test objects in the software application. Therefore, a complete test case for the whole software application may be divided into separate test cases for testing functionalities of respective test objects.

Further, in the present disclosure, each of the plurality of the test cases may only include a functional test part. Any navigating parts may be decoupled from the test case development since the navigating may be performed by a user interaction event.

Further, in the present disclosure, there may be an intrinsic association between a test case and a test object since a test case may be developed for a specific test object. In some embodiments, a test object may be associated with one test case. In other embodiments, a test object may be associated with a plurality of test cases in which each of the plurality of test cases is used to test a portion of the functionality of the test object.

In the following description, the test case according to the present disclosure may also be referred to as an interactive test case. It can be seen from the above that, unlike a complete test case for a whole software application, the interactive test case according to the present disclosure may be used for a specific test object and may only focus on the functionality of the specific test object. For example, user interaction could be used to test some elements of a user interface but not others.

In some embodiments, an association between an interactive test case and a test object may be specified by a software engineer and assigned to the interactive test case during the development of an interactive test case so as to associate the test object with the interactive test case.

In some embodiments, a test object may include a test object identifier which identifies the test object. The test object identifier may be assigned to an interactive test case to associate the test object with the interactive test case. In some embodiments, an interactive test case may be determined as being associated with the first test object if a test object identifier assigned to the interactive test case identifies the first test object.

The test object identifier may be a tag, a number or in any other form so long as it may identify the associated test object and distinguish from other test objects. In some embodiments, in a UI application, a program which is designed to identify and navigate user interface objects indicates the location of the UI element in the UI application may be used as a test object identifier of the UI element.

In some embodiments, during the execution of the functional test on the first test object, predefined input data may be automatically fed into the one or more interactive test cases. Further, actual output data of each interactive test case may be automatically compared to predefined output data to determine whether the functional test is passed or failed.

It can be seen from the above, according to the method 100, user interaction events may help navigate to a test object and the interactive test cases used for the functional test may be focused only on the functionality of the test object. Therefore, the development of the navigating part may be omitted so that the development effort of interactive test cases may be lowered. Further, even though a layout change or a re-implementation of the software application occurs, the interactive test cases may still be reused so long as the functionality of the test object is not changed, thus the maintenance costs may be lowered. In embodiments, only the one or more interactive test cases which are associated with the first test object may be used for executing the functional test for the first test object. This eliminates the need to execute an end-to-end automation test in which test programs developed for other test objects need to be executed together with the test program developed for the first test object. Thus, the execution efficiency may be increased by only running a functional test for the first test object.

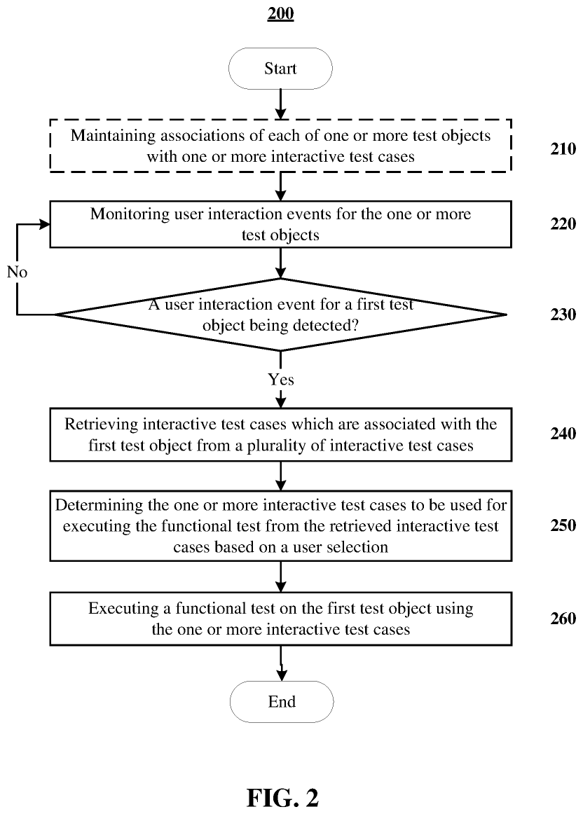

Refer now to FIG. 2, which is a flow chart showing an exemplary computer-implement method 200 for an interactive automation test according to an embodiment of the present disclosure.

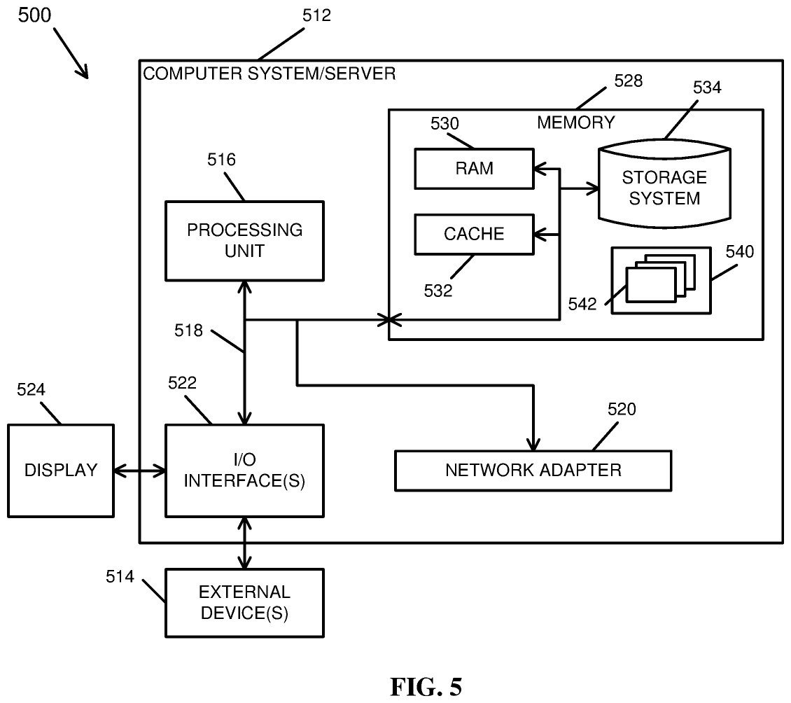

The method 200 is an exemplary implementation of the method 100 in FIG. 1. In the method 200, blocks 220˜230 may correspond to and be comprised the blocks of the method 100. Hereinafter, respective blocks of the method 200 in FIG. 5 will be explained in detail.

In block 210, associations of each of one or more test objects with one or more interactive test cases may be maintained.

In some embodiments, test object identifiers (e.g., tags, numbers, etc.) may be assigned to respective interactive test cases to maintain the associations. In other embodiments, the associations of each of the one or more test objects with one or more interactive test cases may be maintained as a mapping from the test object to the one or more interactive test cases. The test object identifiers or the mapping may be queried so as to determine the one or more interactive test cases which are associated with the test object. It should be appreciated that other methods for maintaining the associations may also be applied to one or more embodiments of the present disclosure.

In some embodiments, an association of a test object with an interactive test case may be updated. The updated association may be a new association of a test object with an interactive test case or an update for a previous association of a test object with an interactive test case, or any other updated association. In some embodiments, the update may be performed when receiving an instruction of updating the association from a user. In other embodiments, the update may be performed in any other methods. Further, blocks 240˜260 may be performed based on the latest associations including the updated association, thus the update may not affect the performing of blocks 240˜260.

In block 220, user interaction events for the one or more test objects may be monitored. In block 230, it is determined whether a user interaction event for a first test object among the one or more test objects is detected.

If a user interaction event for a first test object is detected (“Yes” in block 230), the method 200 may proceed to block 240. Otherwise, if a user interaction for a first test object is not detected (“No” in block 230), the method 200 may go back to block 220 to continually monitor the user interaction events.

In some embodiments, if a user interaction event for a first test object is detected in block 230, a series of user interactions for navigating to the first test object to perform the user interaction event may be recorded as a shortcut. The shortcut may be used for automatically navigating to the first test object next time.

For example, if a user interaction event for a search button of a web page (e.g., a portal Web) is detected, a series of user interactions for navigating to the search button, i.e., the navigation path of “homepage→travel page→hotel booking page→search button” may be recorded as a shortcut. If the shortcut is triggered by a user in a next time, the search button may be automatically navigated to. Therefore, the series of user interactions for navigating to the search button may be omitted.

The shortcut is suitable for a case where a test object needs to be tested for a plurality of times using different interactive test cases. In this way, the shortcut may be recorded at the first time of testing based on a series of user interactions for navigating to the test object. For the rest of the plurality of times, the duplicated series of user interactions may be omitted, and the user may navigate to the test object by simply accessing to the shortcut.

In some embodiments, the user interaction events for the one or more test objects (e.g., the detected user interaction event in block 110 of method 100 or in block 230 in method 200) may include a user's triggering of a shortcut which results in automatic navigation to the first test object.

In block 240, interactive test cases which are associated with the first test object may be retrieved from a plurality of test cases. In some embodiments, the retrieval may be performed based on test object identifiers of interactive test cases. For example, if a test object identifier assigned to an interactive test case identifies the first test object, the interactive test case may be retrieved. In some embodiments, the mapping from test objects to interactive test cases may be inquired to retrieve the interactive test cases which are associated with the first test object.

In some embodiments, an interactive test case may be associated not only with a test object but also with a user interaction event for the test object. As described above, for one test object, a plurality of kinds of user interaction events may be performed which may result in different functionalities of the test object to be tested using different interactive test cases.

Table 1 shows an exemplary association of a test object, a plurality of user interaction events and a plurality of interactive test cases. As shown in table 1, interactive test case 1 is associated with icon 1 and a user interaction event of a tab for icon 1, interactive test case 2 is associated with icon 1 and a user interaction event of a touch and hold for icon 1, and interactive test case 3 is associated with icon 1 and a user interaction event of a drag and drop for icon 1.

TABLE 1

| Test object | User interaction events | Interactive test cases |
|---|---|---|
| Icon 1 | Tab | Interactive test case 1 |
| | Touch and hold | Interactive test case 2 |
| | Drag and drop | Interactive test case 3 |

It should be appreciated that although table 1 shows that only one interactive test case is associated with a test object and a user interaction event for the test object, there may be a plurality of interactive test cases which are associated with a test object and a user interaction event for the test object.

In some embodiments, one or more interactive test cases may be associated with both a test object and a user interaction event. For example, in block 240, a plurality of interactive test cases associated with the first test object and the user interaction event for the first test object detected in block 230 could be retrieved. The one or more interactive test cases can have one or more outcomes to compare to the effect of the user interaction event.

In block 250, the one or more interactive test cases to be used for automatically executing the functional test may be determined from the retrieved interactive test cases based on a user selection.

In some embodiments, in block 240, the retrieved interactive test cases may be listed so as to facilitate a user to select which of the retrieved interactive test cases is to be executed. This may provide a flexibility of the execution of the functional test based on the user's expectation.

The following table 2 lists the retrieved interactive test cases which are associated with the first test object (e.g., the search button). In block 250, a user may select one or more interactive test cases to be executed from the listed interactive test cases. As shown in table 2, interactive test case 4 and interactive test case 7 are selected by the user.

TABLE 2

| | | User |
|---|---|---|
| Test object | Associated interactive test cases | selection |
| Search button | Interactive test case 4 | ✓ |
| | Interactive test case 5 | X |
| | Interactive test case 6 | X |
| | Interactive test case 7 | ✓ |

In block 260, the functional test may be executed on the first test object using the one or more interactive test cases. As for the case shown in table 2, the functional test may be executed on the first test object using interactive test case 4 and interactive test case 7.

Although blocks 240˜260 disclose that the one or more interactive test cases may be determined based on the user selection, it should be appreciated that the retrieved interactive test cases may be automatically assigned as the one or more interactive test cases to be used for automated execution of the functional test based on one or more factors correlating the UI element and the test case. By this way, the user selection may be omitted and the execution of the functional test may be accelerated. For example, the one or more factors used for the correlating could be name of the element, location of the element, graphic on the element, etc.

Further, if there is only one interactive test case retrieved from the plurality of interactive test cases in block 240, which means that there is only one interactive test case associated with the first test object, the block 250 may be omitted. Further, in block 260, the functional test may be executed on the first test object using the one interactive test case.

In some embodiments, two or more test objects may be associated with a same interactive test case.

For example, there may be a “search button 1” located in the ticket booking page of AABBCC portal Web, which has substantially the same functionality as the search button in the hotel booking page of AABBCC portal Web. In this case, the two search buttons may be associated with a same interactive test case for testing the functionality of each search button, thus the development effort may be reduced by half.

In some embodiments, even if a software application is redesigned, interactive test cases associated with the first test object may still be used for the functional test to be automatically executed on the first test object.

For example, assuming that the hotel booking page of AABBCC portal Web is redesigned to split into two subpages, i.e., a domestic hotel booking page and an international hotel booking page. “Search button 2” and “search button 3” are located in the two subpages respectively. The functionalities of the two search buttons are substantially the same, and therefore the two search buttons may be associated with one interactive test case for testing the functionality of each search button. Further, interactive test cases (e.g., interactive test cases 4˜7 shown in table 2) developed for the search button located in the previous hotel booking page before the redesign may be reused for search button 2 and search button 3, since the functionality is not changed and only the navigation path is changed.

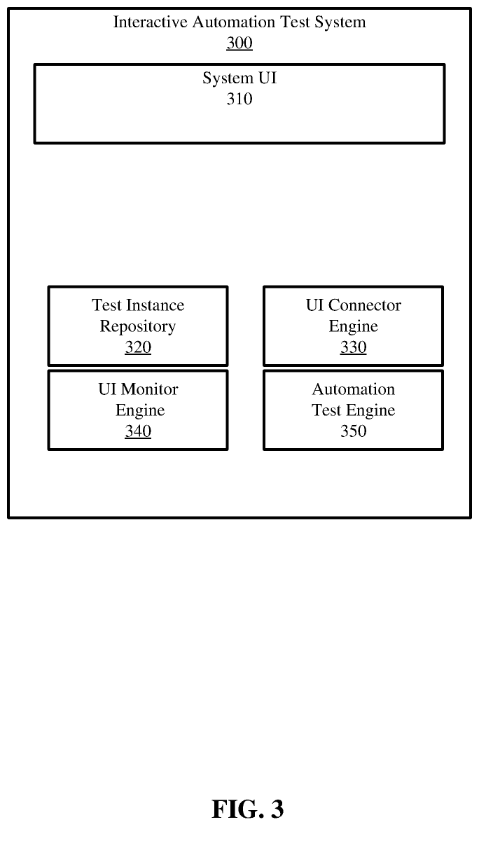

Referring now to FIG. 3, which is a block diagram of an exemplary interactive automation test system 300 according to an embodiment of the present disclosure. The method 100 and the method 200 described above may be implemented in the interactive automation test system 300. Hereinafter, respective blocks of the interactive automation test system 300 in FIG. 3 will be explained in detail.

The interactive automation test system 300 in FIG. 3 is described as being used for testing a UI application. However, it should be appreciated that the interactive automation test system 300 according to the present disclosure may also be used for testing any other software applications.

In some embodiments, the interactive automation test system 300 may be a service in a cloud environment. In other embodiments, the interactive automation test system 300 may be a client application installed in a computer or mobile computing device.

As shown in FIG. 3, the interactive automation test system 300 may include a system UI 310, a test instance repository 320, a UI connector engine 330, a UI monitor engine 340 and an automation test engine 350.

The system UI 310 may be a user interface of the interactive automation test system 300, which is provided for a user to develop, debug and/or start an interactive automation test. Further, results of the interactive automation test may be obtained through the system UI 310.

The system UI 310 may provide API (Application Programming Interface) services, commands, and graphic user interfaces and so on. The API services may comprise opening/closing a browser, locating a URL and operations of UI elements (e.g., locating an element, getting an element value, setting an element value, a mouse operation, and a keyboard operation), and so on.

The system UI 310 may provide test sources (e.g., Eclipse/Junit/Ant) for a software engineer to develop a test program of an interactive test case. The test program may include an XML (Extensive Markup Language) script for web applications, a Java program for client applications, and any other programming languages.

In order to perform a functional test on a UI application, a user may create a test instance for the UI application through the system UI 310, wherein the test instance may include all interactive test cases for testing all UI elements of the UI application. An accessing approach (e.g., a URL and a launch approach for a website UI application) may be defined for the test instance to access to the UI application. Further, a plurality of interactive test cases may be bundled to the test instance for testing functionalities of a plurality of UI elements of the software application.

The test instance repository 320 may maintain test instances, wherein different test instances may be created for different UI applications respectively. Further, interactive test cases bundled to a test instance may also be maintained in the test instance repository 320.

In some embodiments, a user may add/delete test instances or interactive test cases to/from the test instance repository 320 through the system UI 310.

In some embodiments, the test instance repository 320 may maintain associations of each of one or more test objects with one or more interactive test cases. That is, the block 210 in method 200 may be implemented in the test instance repository 320. Further, the block 240 in method 200, in which a plurality of interactive test cases is retrieved, may be implemented in the test instance repository 320.

In some embodiments, two or more test objects may be associated with a same interactive test case so that the interactive test case may be reused. The two or more test objects associated with the same interactive test case may be in a same test instance (e.g., the search button 2 and search button 3 located in two subpages of AABBCC portal Web described above may be associated with the same interactive test case in the same test instance for AABBCC portal Web). Further, the two or more test objects associated with the same interactive test case may be in different instances. For example, an interactive test case (e.g., interactive test case 4 shown in table 2) developed for the search button located in the hotel booking page of AABBCC portal Web may also be used for a “search button 4” of another test instance (e.g., a test instance for another portal Web) having substantially the same functionality. Therefore, interactive test cases may also be reused among different test instances for different software applications.

The UI connector engine 330 may be used for accessing a software application on which a functional test is to be executed after a test instance is created for the software application and started by a user. In some embodiments, if the user starts a test instance for the UI application through the system UI 310, the UI connector engine 330 may access the UI application using an accessing approach defined for the test instance. For example, the accessing approach may include a URL and a launch approach for a website UI application, and the UI connector engine 330 may access the website UI application by opening the URL with the launch approach.

Various tools may be integrated with the UI connector engine 330 as plugins to support different kinds of accesses to software applications. For example, the UI connector engine 330 may bundle Firefox, Chrome, and other web browsers to support website UI application access. In one embodiment, the UI connector engine 330 may interact with OpenGL libraries to operate with OpenGL based applications. In another embodiment, the UI connector engine 330 may bundle Android/iOS simulators to support mobile application operations. By using the UI connector engine 330, the interactive automation test system 300 may control test objects in a software application asynchronously.

The UI monitor engine 340 may be used to monitor and detect user interaction events. The detecting block 110 of method 100 and the blocks 220˜230 of method 200 may be implemented in the UI monitor engine 340.

In response to a user interaction events being detected, the UI monitor engine 340 may retrieve the test instance repository 320 to determine the associated interactive test cases. Further, the UI monitor engine 340 may call the automation test engine 350 to automatically execute the functional test using the associated interactive test cases.

The automation test engine 350 may be used to automatically execute the functional test. The executing block 120 of method 100 and the block 260 of method 200 may be implemented in the automation test engine 350. The block 250 of method 200 may also be implemented in the automation test engine 350 in a case where the retrieved interactive test cases are directly determined as the one or more interactive test cases to be used for executing the functional test. Further, the block 250 of method 200 may be implemented by a user through the system UI 310 in a case where the one or more interactive test cases are determined based on a user selection.

In some embodiments, the automation test engine 350 may get predefined input data and output data through API, apply the input data to the interactive test cases to obtain actual output data and verify whether the actual output data matches the predefined output data.

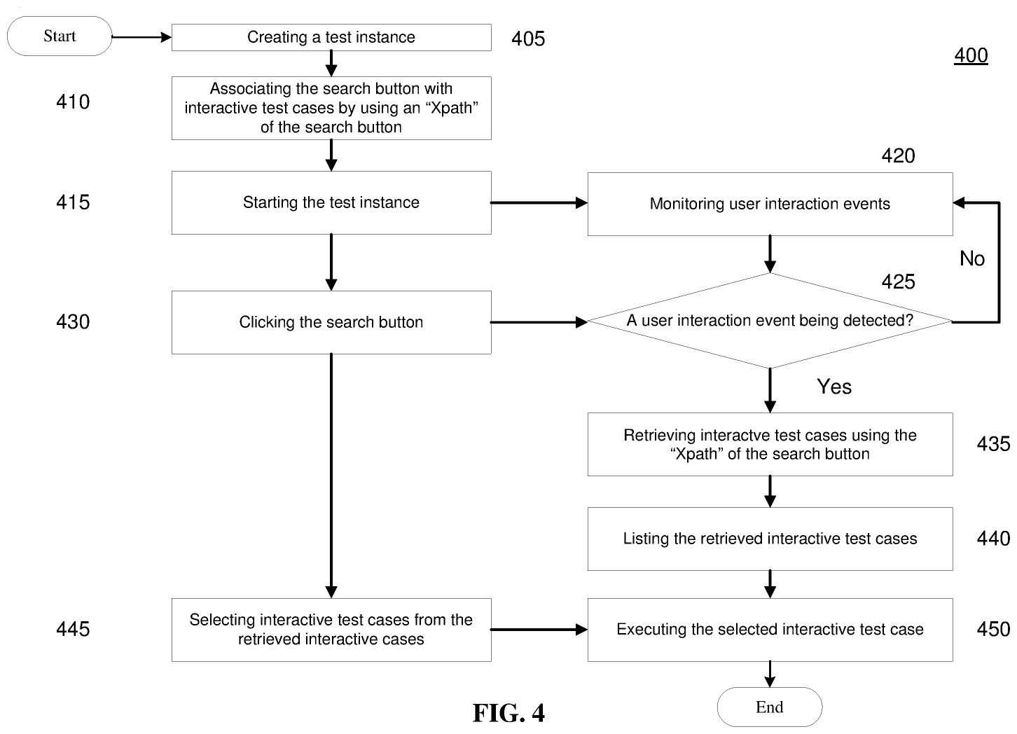

Refer now to FIG. 4, which is a flow chart showing an exemplary computer-implement method 400 for an interactive automation test according to an embodiment of the present disclosure.

The method 400 is an exemplary implementation of the method 100 or method 200, in which the test object is the search button in AABBCC portal Web and the test object identifier is the “XPath” of the search button. The method 400 may be implemented in the interactive automation test system 300.

As shown in FIG. 4, the blocks in the left side (i.e., blocks 405, 410, 415, 430 and 445) may be performed by a user through respective blocks of the interactive automation test system 300, while the blocks in the right side (i.e., blocks 420, 425, 435, 440 and 450) may be performed in respective blocks of the interactive automation test system 300. It should be appreciated that the blocks in the left side may also be performed by other means. For example, blocks 415 and 430 may be performed automatically without user participation.

Hereinafter, respective blocks of the method 400 in FIG. 4 will be explained in detail.

In block 405, a test instance such as “AABBCC portal” may be created for AABBCC portal Web through the system UI 310, with a URL “https://www.AABBCC.com/”.

In block 410, the search button may be associated with interactive test cases (e.g., interactive test cases 4˜7 as shown in table 2) by assigning an “XPath” of the search button to the interactive test cases.

In some embodiments, the interactive test cases may be newly developed and prepared. The developed interactive test cases may be added in the test instance repository 320 and may be reused for other test objects having substantially the same functionality. In other embodiments, interactive test cases existing in the test instance repository 320 may be used for the search button.

In block 415, the user may indicate the interactive automation test system 300 through the system UI 310 to start the test instance “AABBCC portal”. The UI connector engine 330 may access AABBCC portal Web by opening the URL “https://www.AABBCC.com/” with Firefox.

It should be appreciated that after the test instance is started in block 415, a user may also develop interactive test cases through system UI 310, associate a test object with the interactive test cases and add interactive test cases to the test instance repository 320. The interactive automation test system 300 may provide a live environment for the user to develop interactive test cases.

In block 420, the UI monitor engine 340 may monitor user interaction events for UI elements in the test instance “AABBCC portal”. In block 425, the UI monitor engine 340 determines whether a user interaction event is detected.

In block 430, a user interaction event of clicking the search button is initiated by the user. The UI monitor engine 340 may detect the user interaction event in block 425 (“Yes” in block 425), and the method 400 may proceed to block 435. Otherwise, if there is no user interaction event being detected (“No” in block 425), the method 400 may go back to block 420 to continually monitor user interaction events.

In block 435, the “XPath” of the search button may be used to retrieve interactive test cases which are associated with the search button. The interactive test cases assigned with the “XPath” of the search button may be retrieved from the test instance repository 320.

In block 440, the retrieved interactive test cases (e.g., interactive test cases 4˜7 as shown in table 2) may be listed through the system UI 310 to the user for selection.

In block 445, the user selects interactive test cases to be executed (e.g., interactive test cases 4 and 7 as shown in table 2) from the retrieved interactive test cases through the system UI 310.

In block 450, the automation test engine 350 automatically executes the selected interactive test cases (e.g., interactive test cases 4 and 7 as shown in table 2).

In some embodiments, a user experience test for one or more test objects (e.g. the first test object) may be performed in a same session in which the functional test is automatically executed.

The user experience test focuses on look and feel experiences and visual/audio effects. During the user experience test, a user may perform a series of user interactions to navigate to a test object to perform the user experience test on the test object. The series of user interactions may be the same as the user interaction event for navigating to the test object to perform a user interaction event on the test object during the functional test according to the present disclosure. Therefore, a user experience test for the one or more test objects may be performed in a same session in which the functional test is automatically executed, so that the testing effort for the user experience test may be lowered.

### Computer System

In an exemplary embodiment, the computer system is a computer system 500 as shown in FIG. 5. Computer system 500 is only one example of a computer system and is not intended to suggest any limitation as to the scope of use or functionality of embodiments of the present invention. Regardless, computer system 500 is capable of being implemented to perform and/or performing any of the functionality/operations of the present invention.

Computer system 500 includes a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 512 may be described in the general context of computer system-executable instructions, such as program modules, being executed by a computer system. Generally, program modules may include routines, programs, objects, components, logic, and/or data structures that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in computer system 500 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 512 typically includes a variety of computer system readable media. Such media may be any available media that is accessible by computer system/server 512, and includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions/operations of embodiments of the invention.

Program/utility 540, having a set (at least one) of program modules 542, may be stored in memory 528 by way of example, and not limitation. Exemplary program modules 542 may include an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the present invention.

Computer system/server 512 may also communicate with one or more external devices 514 such as a keyboard, a pointing device, a display 524, one or more devices that enable a user to interact with computer system/server 512, and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems.

### Cloud Computing

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

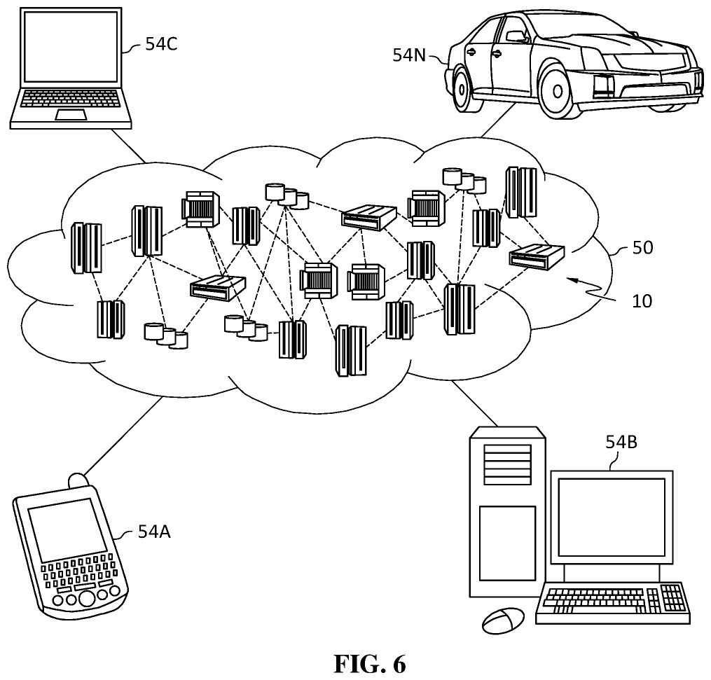

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

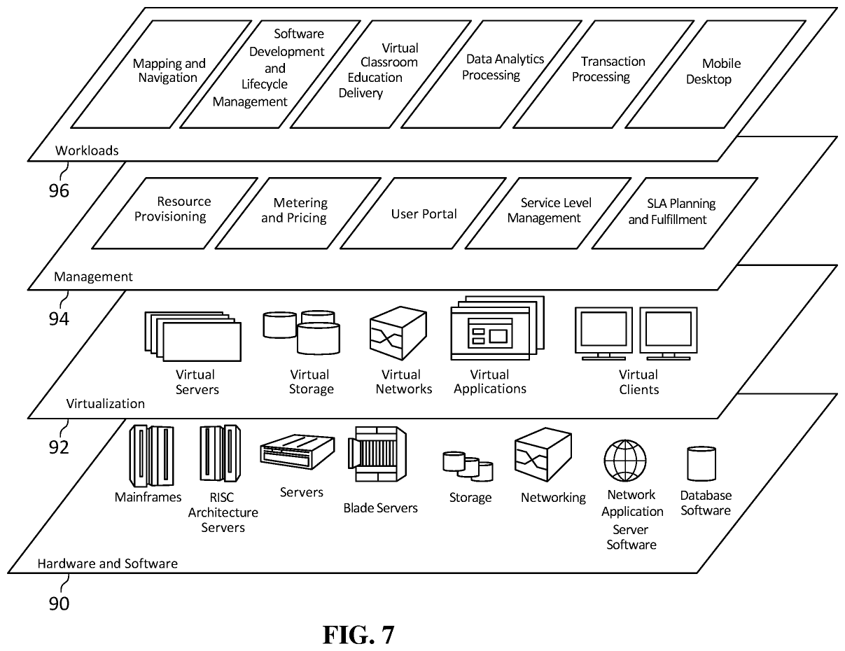

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 90 includes hardware and software components. Examples of hardware components include: mainframes; RISC (Reduced Instruction Set Computer) architecture based servers; storage devices; networks and networking components. In some embodiments, software components include network application server software.

Virtualization layer 92 provides an abstraction layer from which the following examples of virtual entities may be provided: virtual servers; virtual storage; virtual networks, including virtual private networks; virtual applications and operating systems; and virtual clients.

In one example, management layer 94 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 96 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

### Computer Program Product

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose.

1. A computer-implemented method comprising:
detecting a user interaction with a first test object of a user interface;
monitoring an effect of the user interaction with the first test object;
querying one or more test object identifier for the first test object;
retrieving, based on the querying and from a plurality of test cases, interactive test cases that are associated with the first test object;
determining one or more interactive test cases of the retrieved interactive test cases for a functional test of the first test object; and
executing a functional test on the first test object using the one or more interactive test cases.

2. The computer-implemented method according to claim 1, wherein the one or more interactive test cases are determined as being associated with the first test object in response to a test-object identifier assigned to the one or more interactive test cases identifying the first test object.

3. The computer-implemented method according to claim 1, further comprising:
maintaining associations of the first test object with the one or more interactive test cases.

4. The computer-implemented method according to claim 3, wherein the maintaining further comprises:
updating an association of the first test object with an interactive test case.

5. The computer-implemented method according to claim 3, wherein the one or more interactive test cases are further associated with the user interaction for the first test object.

6. The computer-implemented method according to claim 3, wherein two or more test objects are associated with a same interactive test case.

7. The computer-implemented method according to claim 6, wherein the two or more test objects associated with the same interactive test case are in different test instances.

8. The computer-implemented method according to claim 1, wherein a user experience test for the first test object is performed.

9. The computer-implemented method according to claim 1, wherein the user interaction for the first test object is a user's triggering of a shortcut which results in an automatic navigation to the first test object.

10. The computer-implemented method according to claim 9, wherein a series of user interactions for navigating to the first test object to perform a user interaction is recorded as the shortcut.

11. (canceled)

12. The computer-implemented method according to claim 1, wherein the method is executed in a cloud environment or a client application.

13. A system comprising:
one or more processors;
a memory in communication with the processor, the memory containing program instructions that, when executed by the processor, are configured to cause the processor to perform a method, the method comprising:
detecting a user interaction with a first test object of a user interface;
monitoring an effect of the user interaction with the first test object;
querying one or more test object identifier for the first test object;
retrieving, based on the querying and from a plurality of test cases, interactive test cases that are associated with the first test object;
determining one or more interactive test cases of the retrieved interactive test cases for a functional test of the first test object; and
executing a functional test on the first test object using the one or more interactive test cases.

14. The system according to claim 13, wherein the set of computer program instructions is executed by the at least one or the one or more processors to further perform an action of:
maintaining associations of the first test object with the one or more interactive test cases.

15. The system according to claim 13, wherein an interactive test case is determined as being associated with the first test object if a test object identifier assigned to the interactive test case identifies the first test object.

16. The system according to claim 13, wherein the user interaction is a user triggering a shortcut which results in an automatic navigation to the first test object.

17. A computer program product, the computer program product comprising a computer readable storage medium having program instructions embodied therewith, the program instructions executable by a computer to cause the computer to:
detect a user interaction with a first test object of a user interface;
monitor an effect of the user interaction with the first test object;
monitoring an effect of the user interaction with the first test object;
query one or more test object identifier for the first test object;
retrieve, based on the querying and from a plurality of test cases, interactive test cases that are associated with the first test object;
determine one or more interactive test cases of the retrieved interactive test cases for a functional test of the first test object; and
execute a functional test on the first test object using the one or more interactive test cases.

18. The computer program product according to claim 17, wherein the program instructions further cause the computer to:
maintain associations of the first test object with the one or more interactive test cases.

19. The computer program product according to claim 17, wherein an interactive test case is determined as being associated with the first test object if a test object identifier assigned to the interactive test case identifies the first test object.

20. The computer program product according to claim 17, wherein the user interaction is a user triggering a shortcut which results in an automatic navigation to the first test object.
